(19) United States
(12) Patent Application Publication
(10) Pub. No.: US 2002/0132209 A1
(43) Pub. Date: Sep. 19, 2002

(54) Method and apparatus for automating tutoring for homework problems

(76) Inventors: Charles Alexander Grant, Kensington, CA (US); Robert Andrew Bekes, Berkeley, CA (US); Casey Benton Rogers, Sant Barbara, CA (US); James Madison Scott, El Cerrito, CA (US); Roger Alexander Purves, Berkeley, CA (US)

Correspondence Address: HOTMATH.COM INC, CHARLES GRANT, 18 SUNSET DRIVE, KENSINGTON, CA, 94707, US

(21) Appl. No.: 09/961,047

(22) Filed: Sep. 20, 2001

Related U.S. Application Data
(60) Provisional application No. 60/234,454, filed on Sep. 21, 2000.

(51) Int. Cl. G06F 17/00; G06F 7/00; G09B 19/00

(52) U.S. Cl. 434/118; 707/104.1

(57) ABSTRACT

Methods and apparatus are provided for storing and providing access to content components representing solutions to published text-book problems. Tutorials are composed of solution, which in turn are composed of problem descriptions, solutions, hints, steps, queries, Socratic queries, formulas and figures, and guesses. These solutions can be stored in a relational database, or in files using the HM(SL format.

### FIELD OF THE INVENTION

The field of the present invention relates to an intelligent web-based tutoring system, whereby educational material can be authored, stored, customized and accessed over the world-wide-web.

### RELATED APPLICATIONS

This application is related to the co-pending applications of the applicant, filed with the present application and assigned to the assignee of the present application entitled, Method and Apparatus for One-Key Learning with an Automated Tutor; Method and Apparatus for Acquisition of Educational Content Method and Apparatus for Delivery of Educational Content, the disclosures of which are hereby incorporated by reference.

### BACKGROUND OF THE INVENTION

High-school and college students are often discouraged from continuing with math and science courses because the material seems too difficult. Many of these students fail to reach their potential for understanding and succeeding in math and math-related studies, because they are not as fortunate as others who have math-talented relatives, friends, or tutors who can help them

The present invention was created by teachers who recognize that all students do not understand every lesson in the class time allotted. The guideline for this invention is that Socratic solutions are the best method of learning how to solve problems.

This invention was designed for the student in class who needs a little more help understanding how to do the homework. Maybe this student misunderstood something in class, got confused, or simply missed the class. And maybe this student can't come to office hours, and doesn't have a friend or relative available to help right now. And can't afford a tutor.

In recent years we have experienced a change in student attitudes, whereby when a student gets stuck on the homework, the student is much more likely to stop working on it. The student either blames the teacher or simply doesn't care.

The educational content is primarily intended to enhance the self-teaching capabilities of students. As such, it contains hints which are helpful clues for students who don't know how to proceed. When the select the ‘Hint’ button, a suggestion will appear. This suggestion should be sufficient to enable the student to proceed with their opwn paper and pencil solution. Students who don't need a hint may skip it.

Often, more then one of the suggestions may be correct. When a student makes a choice, a response appears. To enhance the learning experience, students can try any or all of the choices and internalize all responses. Some answers suggest that the student proceed on their own. In case the student knows the answer, he/she can proceed to the net step without answering.

A solution can be restarted by selecting the ‘restart ’ button and going back to the beginning. Alternatively, students can step back one step by selecting the ‘back’ button.

At the end of each solution- students are requested to ‘grade’ the solution.

This feature enables the collection of important marketing statistics. After grading the solution students are refferred by to the problem index.

The delivery system is can also be used to evaluate existing solutions. Students can start from an existing solution and mark on it the steps defined by the delivery system Before moving to the next step, all possible answers can be examined and compared. is capability further enhances the understanding of the subject matter and improves the capabilities of students to generate solution ideas.

### SUMMARY OF THE INVENTION

The preferred embodiment of the present invension offers tutorial solutions for many of the homework problems in popular math and science textbooks. We know that EVERY student can use some help with homework from time to time. The kind of help that EXPLAINS in detail how to solve problems, so you can learn to solve others like it

The present invention seeks to provide thoughtful, encouraging, tutorial solutions that enhance learning. It is primarily helpfil for the “B” and “C” students. The “A” students might also use our site to check their work. It is expected that students will use the invension when stuck on a problem, need help, or simply review before an exam. A way to think about the solutions stored by the presdent invention, one can imagine what a teacher would say when a student comes to office hours and says: “I'm having trouble with this problem.”

The present invention also provide added value to parent, who can now have fun working on math problems with their students. Parents don't need to be embarrassed that they don't remember the details of a methodology or a specific solution. Student should no longer suffer from rustiness of their parent.

The tutorial solutions are presented in a way that a paid tutor might. Cognitive scientists believe that tutorial explanations of solutions is the state-of-the-art method for learning math and science.

### BRIEF DESCRIPTION OF THE DRAWINGS

FIG. 1 shows the data structure representing the educational content.

FIG. 2 shows the server implementation structure.

FIG. 3 shows the design and class structure.

FIG. 4 shows a sample XML component definition.

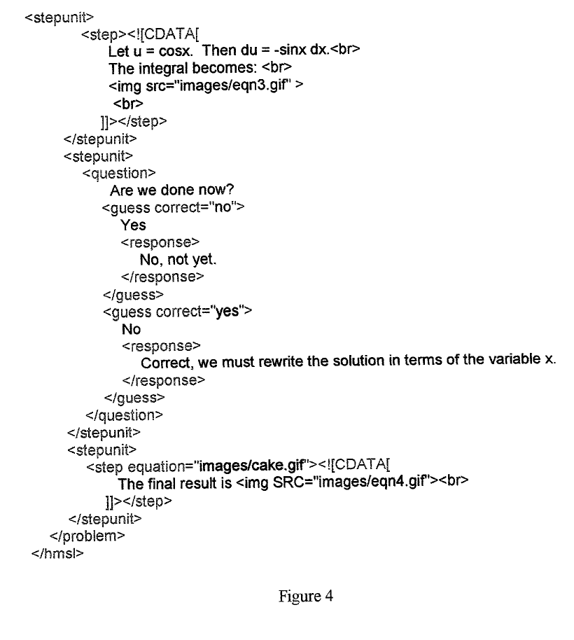

FIG. 5 shows the DTD for a component definition.

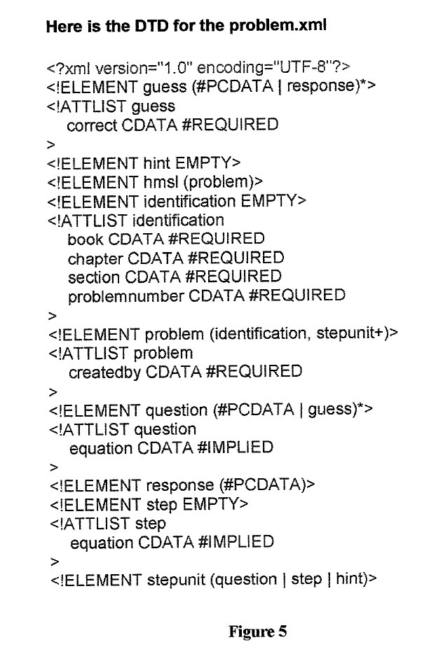

### DETAILED DESCRIPTION OF THIE PREFERRED EMBODIMENTS

A problem solution consists of a problem identification followed by a list of items constituting the solution. These items can be hints, questions, or steps. HMWSL defines a method of coding each of these items that is simple and allows figures and equations generated using Equation Editor to be integrated easily into the item Figures and graphs to be inserted in solutions must be GIF files, 300 pixels by 300 pixels square. See the Figure tag definition.

Hints are used to guide the student who is having a difficulty when solving a problem. A hint should describe what a tutor would say to a student having trouble with the problem to get them going. Generic statements that repeat the problem statement are not helpful (e.g., “Solve the equation”). Also, at the beginning of a step following a hint, the text amplifies on the hint as the beginning of the step: a student may or may not have actually requested a hint so it must be repeated. Sometimes the problem is so elementary that a hint just doesn't make sense. In that case, a hit may comprise of a very brief statement (e.g., “Substitute”).

Questions are used in addition to the hints. Questions are good leafing tools and get the student involved in using the solutions. A query includes a question followed by a series of two or more responses, each of which is labeled as either correct or incorrect. A question may also contain formulas and figures, which are built in the same way that formulas and figures within hints and steps are built.

To describe components, a special purpose language was devised. Each solution component begins with a “tag”, which is a symbol that identifies the component. All tags consist of a caret (ˆ ) followed by a letter or letters; tags are not case sensitive. Any exceptions to case insensitivity in HMISL must be explicitly noted. “ˆ PH” and “ˆ ph” are identical in meaning. A tag should be followed by at least one white-space character. A tag can occur anywhere on a line; but as a matter of style, it is preferred to put each tag on a new line (though it does not need to be in the first column of a line.) Following a tag there can be any text or Equation Editor figures (equations). The tag marking the next component terminates a solution component. When necessary, we can define an end tag for each component; but this is avoided whenever possible since it requires more typing for solution authors. In general, parsers are easier to write and more robust in detecting errors when the statements of the language have terminators. The components of a solution must be entered in the order that the student will view them

Authoring components with this language requires following the following rules:

1. The first element of a solution must be a hint or a question.

2. A question must be followed by a step.

3. A hint must be followed by a step

4. A step (except the last step) must be followed by either a question or a hint.

5. A question must have at least two guesses

6. A question must have at least one right guess.

7. A guess must have a response.

Any figure (graphic) must occur within a step, and must be re-referenced if desired to be shown in subsequent steps.

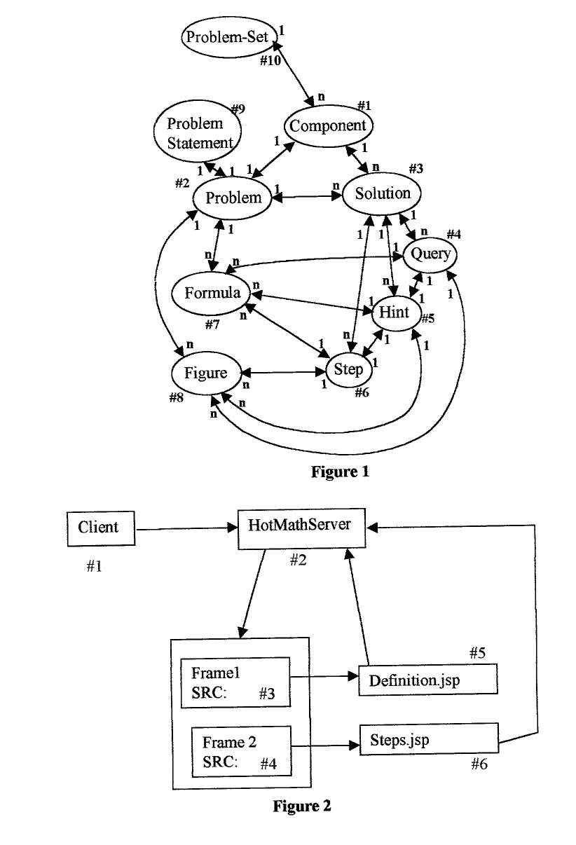

Turning now to FIG. 1, there is shown the model, which is the data structure representing the educational content. The content is represented in the database using XML (extended markup language), which is used as a data description laugnage. The content includes, but not limited to, a collection of problem-sets #9. Each problem set is composed of a set of components #1, each of which composed of solutions pair #2, whereby each problem may be mapped to at most one solution #3. Every solution must map to exactly one problem #4 and at most one problem statement #9. Many problems will have more than one valid solution, crating a one-to-many mapping between components and solutions. Each problem is composed of, but is not limited to, a collection of mathematical expressions #7 and a collection of images conteinining information relevant to the problem #8 such as figures, graphs or illustrations. Each solution is composed of; but not limited to, an ordered list of queries #4, hints #5 and steps #6. Each query, hint or step may include text, mathematical formulas and figures.

The said model is stored in a database using a database schema which includes the following tables: a solutions table containing at most one raw for each solution; a comments table containing at most one row for each comment; a book information table containing at most one row for each book; a grades table containing at most one row for each user-problem pair.

TABLE NAME: SOLUTIONS
DESCRIPTION: Used to record a single ‘solution’

| FIELD | TYPE | USE |
|---|---|---|
| PROBLEMINDEX | INT | PRI KEY (autocreated) |
| PROBLEMNUMBER | TEXT | |
| BOOKTITLE | TEXT | FOR KEY (BOOKINFO) |
| CHAPTERTITLE | | TEXT |
| SECTIONTITLE | TEXT | |
| PROBLEMSET | TEXT | |
| PAGENUMBER | INT | |
| SOLUTIONXML | TEXT | |
| INPUTTER | TEXT | |
| LOADORDER | INT | |
| CREATEDBY | TEXT | |
| CREATEDATE | DATE | |

TABLE NAME: SOLUTIONCOMMENTS
DESCRIPTION: Used to record ongoing comments about a
solution.

| FIELD | TYPE | USE |
|---|---|---|
| PROBLEMINDEX | INT | PRI KEY, FOR |
| | | KEY |
| SOLUTIONCOMMENTS | TEXT | |
| COMMENTDATE | DATE | |

TABLE NAME: BOOKINFO
DESCRIPTION: Used to record a single ‘book’.

| FIELD | TYPE | USE |
|---|---|---|
| TEXTCODE | TEXT | PRI KEY, FOR |
| | | KEY |
| TEXTNAME | TEXT | |
| EDITION | TEXT | |
| PUBLISHER | TEXT | |
| PUBDATE | DATE | |
| AUTHOR | TEXT | |
| ISBN | TEXT | |
| STARTDATE | DATE | |
| ENDDATE | DATE | |
| IMGEFILE | TEXT | Name of bitmap |
| | | to use. |

TABLE NAME: SOLUTIONGRADES
DESCRIPTION: Used to store user response to solutions

| FIELD | TYPE | USE |
|---|---|---|
| PROBLEMINDEX | TEXT | PRI KEY, FOR |
| | | KEY |
| USERCODE | TEXT | PRI KEY |
| GRADE | TEXT | |
| COMMENTS | TEXT | |
| GRADEDATE | DATE | |

Components can be uploaded to the server by aggregating them into files. This is achieved using the HotMath Solution Language (HMSL), described next.

The file header identifies the file as containing problem solutions coded in HMWSL. It must contain a code name for the textbook and the file's author ID code. Other required content may be defined later. The tag for the file header is ˆ HMSL. The format is: ˆ HMSL ˆ TEXT HotMath textbook code; ˆ AUTHOR Author_ID_Code. For example, “ˆ hmsl ˆ TEXT Brown1; ˆ AUTHOR 105” can be used. The “ˆ TEXT” and “ˆ AUTHOR” attributes are required. When a textbook is entered into the HotMath system, it will be assigned a unique identification code. This unique code must be used as the value of the TEXT attribute. The semicolon separating the TEXT and AUTHOR attributes is required. Each solution author will be assigned a unique identification code, and this code must be used instead of the author's name. There can be only one File Header tag in an HM/SL file.

The set header identifies a solution in the file as belonging to a particular chapter, section and group within the chapter. The chapter identifier is required. The section and group identifiers are optional. If the textbook has section and group identifiers for a set of problems, these identifiers should be included in the Set Header tag. A set header applies to all subsequent problems in the file until a new set header is encountered. The tag is ˆ SH, and the format is “ˆ SH Chapter; Section. Problem Set”. For example, ˆ Sh 5; Review;Review Exercises” can be used. The chapter identifier is required. The section and group identifiers are optional. Semicolons must separate all items. If the section is omitted but the group is present,. then an extra semicolon is needed; see the examples. Solution authors should take care that the chapter, section, and problem set identifiers are entered exactly as they appear in the textbook, since these identifiers will be used to generate an overall index that students will use to locate solutions on the Internet site.

The problem header identifies the problem solved, by listing the page number and problem number. The problem identification is required and must be the first component of every HM/SL solution. Its tag is ˆ PH and its format is “ˆ PH Page Number; Problem Number.” For example, “ˆ ph 23; Exercise 2” can be used. Both the page and problem number are required, as is the semicolon separating the individual items.

The step header identifies a partial solution of the problem. When displayed in the sequence that they occur in the HM/SL file, the steps give a complete solution to the problem As a student proceeds through the solution, at each stage the tutor will display the steps that have already been reached, plus the next item, which will be either a hint or a query that guides the student to discover the next step. The tag is ˆ S and the format is ˆ S Solution text, equations, and optional figure”. For example, “ˆ S Multiply both sides of the equation by x². This gives . . . ” can be used. If there is an accompanying figure to be displayed in the figure frame of the tutor, it must be created using either Equation Editor or another graphics program that can create either GIF or JPG files. To include a figure in a step, insert a Figure tag immediately following the step.

The hint header identifies a clue that the student can display on request. It is displayed in a separate frame from the main solution, called the hint frame. The tag is ˆ H and the format is “ˆ H Text and equations”. For example, “ˆ H Try integration by parts” can be used.

The question header identifies a choice of different ways of continuing the solution. A question can be given to the student either at the beginning of the solution or after any step. A complete question consists of a question tag, some text that asks the question, followed by at least two Guess-Response pairs. The tag is ˆ Q and the format is “ˆ Q Text and equations.”. For example, “ˆ Q What technique would be best for this integral?”.

The guess header identifies a (usually) short text item that is one possible answer to the question that it follows. It will be displayed below the question. There are two forms of the guess tag, ˆ RG and ˆ WG. ˆ RG should be used for a correct (Right) guess, ˆ WG for an incorrect (Wrong) guess. The format is “ˆ rg Text and equations” and “ˆ wg Text and equations”. For example, “ˆ rg Integration by parts.” And “ˆ wg Algebraic substitution” can be used. A Guess Response must follow a guess.

The guess-response header identifies the item that the student will see if the corresponding guess is selected. The guess response will be displayed in the hint frame. The tag is ˆ R and the format is “ˆ r Text and equations”. For example, “ˆ R Integration by parts is not appropriate for this problem” can be used.

The figure header identifies an image, generated with a drawing or graphing program, intended to be displayed in the figure frame of the tutor as part of some step in the solution The figure is displayed at the same time as the step that it belongs to. Figure files should be saved in the same directory as the MS Word DOC file containing the solution to which it belongs. Names of figure files should be generated using the following pattern: f-Page Number-ProblemNumber-Set ID+Figure Number+extension. The Set ID may be omitted if the text does not have a label for a given set of problems. If the set label is long (e.g., “Written Exercises”), it should be abbreviated (e.g., “WR”). The figure number is an integer that should be 1 for the first figure associated with a problem and increases for each additional figure associated with the problem.

The format is “ˆ F File specification”. For example, “ˆ F f-25-2-rp-3.gif” can be used. Note that figure file names may not contain uppercase letters. For example, the first figure associated with problem 27 on page 159, in an unlabeled problem set, would be saved as “f-159-27-1. gif”. The third figure associated with problem 2 of the Review Problems on page 25 would be saved as “F-25-2-RP-3. gif”.

Solution authors will need to group their solutions into separate HM/SL files so that figure name conflicts are avoided.

The comment header identifies any text that right be useful for reading the HM/SL file. It is discarded when the HM/SL file is processed to create web content. A comment begins with a comment tag and extends to the end of the line on which it occurs. The tag is ˆ C and the format is “ˆ c Text”. For example, “ˆ c This text is a comment” can be used.

The bookmark header identifies a tag inserted by the HM/SL author to mark a location in the HMWSL file. It is intended only to be used in incomplete files. If the HM/SL file processor encounters a bookmark tag, it will display the text of the bookmark, number of the line where the bookmark was found, and terminate. The tag is ˆ B and the format is “ˆ b text”. For example, “ˆ B This problem is incomplete; the fourth step is missing” can be used.

Table 1 summarizes the headers and their tags.

| | | |
|---|---|---|
| File Header: | Tag: | \hat{ }HMSL |
| | Example: | \hat{ }hmsl \hat{ }TEXT Stewart1; \hat{ }AUTHOR 120 |
| Set Header: | Tag: | \hat{ }SH |
| | Example: | \hat{ }sh 3; 5 |
| | | \hat{ }Sh 5; ;Review Problems |
| | | \hat{ }Sh Appendix A; ;Miscellaneous problems |
| Problem Header: | Tag: | \hat{ }ph |
| | Example: | \hat{ }PH 5;39 |
| Step: | Tag: | \hat{ }S |
| | Example: | \hat{ }S Multiply both sides of the equation |
| | | by x². This gives . . . |
| Hint: | Tag: | \hat{ }h |
| | Example: | \hat{ }H You could try integration by parts. |
| Question: | Tag: | \hat{ }Q |
| | Example: | \hat{ }Q What technique would be best for this |
| | | integral? |
| Guess: | Tag: | \hat{ }rg or \hat{ }wg |
| | Example: | \hat{ }rg Integration by parts. |
| Guess Response: | Tag: | \hat{ }R |
| | Example: | \hat{ }R Integration by parts is not appropriate |
| | | for this problem. |
| Figure: | Tag: | \hat{ }F |
| | Example: | \hat{ }F f-25-2-rp-3.gif |
| Comment: | Tag: | \hat{ }c |
| | Example: | \hat{ }c The remainder of this line is a |
| | | comment |
| Bookmark: | Tag: | \hat{ }B |
| | Example: | \hat{ }B This problem is incomplete; the |
| | | fourth step is missing. |

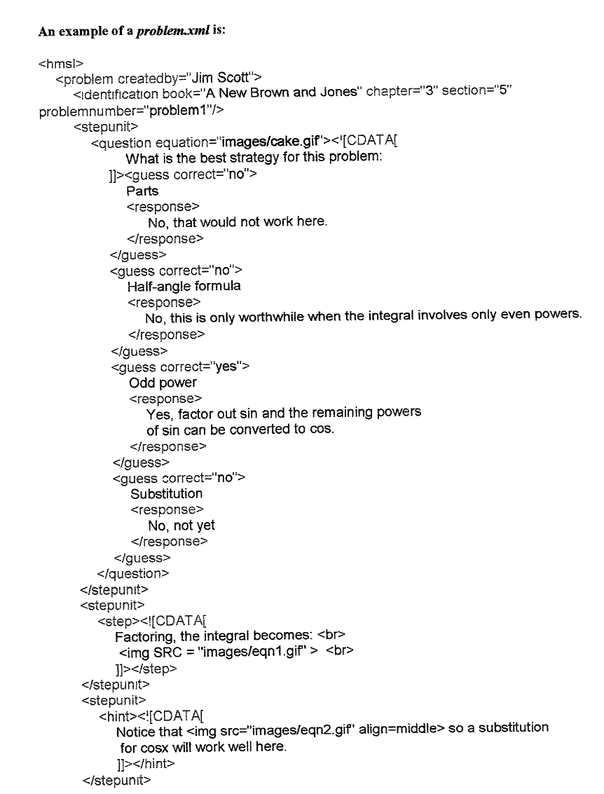

Turning now to FIG. 3, shown is an example description of a component. Following is an example of two problems stored on the server. The problems directory contains two subdirectories, P1 and P2. The directory P1 contains the file problem. xml, as well as a list of image files img1.gif . . . img3. gif. The directory P2 contains the file problem.xml, as well as a list of image files dmg1.gif,fdf.gif and img3.jpg.

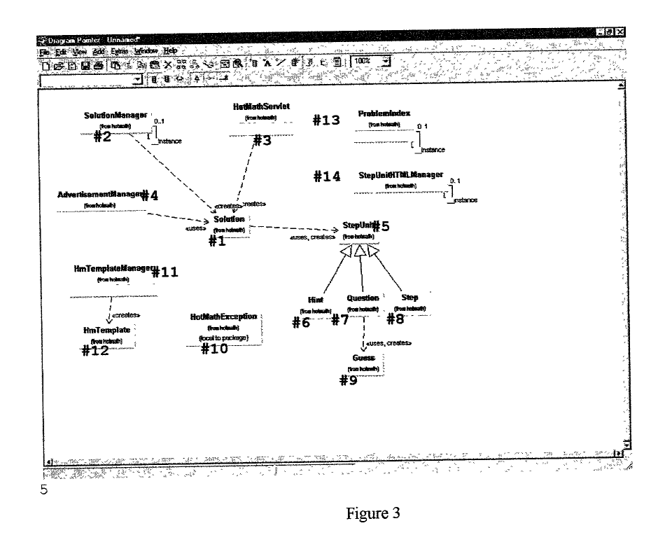

Turning now to FIG. 2, shown is the structure of the current server-side implementation for storing and accessing components. The client #1 commnicates with the HotMath application server #2. The said server constructs two frames: Frame 1 #3 and Frame 2 #4. The said Frame 1 is constructed by script Definition jsp #5. The said Frame 2 is constructed by the script Steps.jsp #6.

To access components an HTTP-Get or HTTP-Post can be used by constructing URLs. For example to access a single solution a URL of the following form is used:

http://www.hotmath.com/staging/tutor/hotmath3.jsp?index=brown97_99_999_SampleProblems_1_1000

Once an HTTP request is received for accessing a single solution, the server accesses the solution through caching mechanisms in a two-phase process. First, a check is made to determine whether the solution resides in the cache. If it is not found, then a check is made to determine whether the solution resides in the database or other persistent storage. When the requested solution is found, the retrieved solution is given in HTML and may contain JavaScript. The said retrieved solution is delivered in its entirety to the client through the response stream in a single response. The transmitted JavaScript contains a set of routines that manipulate the user's browser to dynamically to construct the various pieces of the retrieved solution. If the solution references images (e.g., external GIF files), they are read from the server through subsequent requests, when the web-browser renders the page.

Turning now to FIG. 2, shown is the class structure of the current server-side solution. A solution #1 is constructed by the solution manager #3 from within a servlet #4. The advertisment manager uses #4 the solution to post directed advertising. The said solution create a StepUnit #5, which could be either a Question #6, a Hint #7 or a Step #8. A question can create and use a guess #9. Whenever an operation fails, an HotMath exception #10 is constructed and thrown. The template manager #11 constructs and uses individual templates #12. The ProblemIndex manager #13 is used both to give a unique name to a new a problem as well as to retrieve an existing problem whose name is known. The StepUnitHTML manager #14 is used to generate the render a said StepUnit object in HTML format, which can be subsequently transmitted to the client via HTTP response.

Mathematical formulas are represented in an XML structure derived from word-processing formulas authord with special purpose editors (e.g., MS Word Formula Editor). A methematical formula is stored as a tree whose root refers to the entire formula, and a node in the tree refers to a subformula A subformula can be an expression sorounded with paranteces, a multiplication of expressions, a summation of expressions, an individual variable, or a string of plain text.

The current implementation enables generating a report of all stored problems.

When the user selects a problem from the problem-list the following happens:

The HotMathServer is contacted to get the html-solution for the requested problem index. A request is in the form:

http://HotMathServer?problemindex=ProblemIndex

For example:

<a href=“HotMathServer?problemindex=P1”>The First Problem</a><br>

The HotMathServer will obtain a Solution Java object that encapsulates a complete solution. This will be cached on the server. Only if the interm-solution is modified (re-compiled) will it be re-read.

The HotMathServer will obtain the contents of the hotmath.jsp file. This template file defines the frames and global JavaScript code. It also does a token replacement before sending the result to client. Currently, the only token that is replaced is Problem Index. The problem index is extracted from the URL that made the html-solution request.

The following is an example:

<html>

<head>
<title>Problem Template</title>
</head>
<!-- Main element is a frameset with 3 rows --->
<frameset rows = “15%, 76%, *”>
<!-- First row has two frames - problem statement or ID

and an advertisement. --->

<frameset cols = “50%,*”>

```
  <frame src = “hm_problem_definition.jsp?problemindex=$$ProblemIndex$$”
  name=“ProbDefFrame“>
```

<frame src = “hm_problem_ad.jsp?problemindex=$$ProblemIndex$$” name = “AdFrame”>

The HotMathServer replaces any tokens enclosed in the form of $$Token$$ with it's value. For example:

<frame src=“ProbDef. jsp?problemindex=$$ProblemIndex$$” name=“ProbDefFrame”>

Would be replaced with:

<frame src=“hm_problem_definition.jsp?problemindex=TheRequestedProblem” name=“ProbDefFrame”>

The HotMathServer would then return the text of the template and token replacement back to the client.

The Client Browser would then fill in each frame with it's SRC. The SRC of each frame is a JSP page that communicates back with the HotMathServer for any required information.

Solutions are composed of queries, hints and steps. Each step sequence is made up a number of StepUnits. Each StepUnit has it's own “template” file that .lives the in the Template directory off of the base HotMath HTML files directory. These template files can be modified with any HTML formatting markup to achieve the look needed. For example, the following is the template used to display a finalized step:

<a href=‘javascript:parent.showStepUnit($$StepNumber$$)’>Back</a>
<br><br>
<p> ($$StepNumber$$) $$StepText$$<p>
<br><hr>
NOTE: Notice the $$StepNumber$$ and $$StepText$$
tokens. The server will
replace these with the appropriate text
before it is inserted into the Step Sequence.

Currently, the following templates have been defined:

| Template Name | Description |
|---|---|
| hm_grade.html | Used to display the Grade form after the end |
| | of last step. |
| hm_hint.html | Used to display a hint m the Hint Frame |
| hm_hint_random.html | Used to display the “Random” hint |
| hm_question.html | Used to display a question. |
| hm_question_guess.html | Used to format the guess/responses for each |
| | question |
| hm_step.html | Use to format a complete step. |

Each component of the educational content can be associated with presentation requirements and style. For example, images and formulas can be organized using a border layout, whereby text appears to the north, a graph appears to the south, an illustration appears in the center and a selection of possible solutions appears to the east.

A tutorial is composed of but not limited to, said components (i.e., said problem-solution pairs), and contains a set of attribute value pairs (e.g., tutorial name). Two tutorials can share components (e.g., T₁∩T₂≠Ø) #2. One tutorial can subsume other tutorials (e.g., T₃⊃T₁). Tutorials could be disjoint (e.g., T₁∩T₄=Ø). Components may be orphans not contained in any tutorial.

A user profile consists of but not limited to, a collection of attribute-value pairs. Attributes can be user information (e.g., user name), tutorial information (e.g., tutorial name), component IDs, or other properties of user profiles.

The database stores, for each user, several types of roles and persiossions. Administrators can define new users (i.e., including their passowrds and permissions), author new components and associate them with tutorials, as well as simulate the execution of the tutorial to test all its features and possible scenarios. Authors can create new components, organize them within their own tutorials (i.e., but cannot attach them to tutorials of other trainers or administrators), as well as simulate the execution of the tutorial to test all its features and possible scenarios. Students are only allowed to run tutorials and post feedback.

A component may contain revision history. Each item in the history is composed of, but not limited to, the name of the author or its profile ID, the reason for the change (e.g., creation, clarification) and the time that the update was performed.

A web-based client-server architecture is applicable to the present invention. There are web-clients communicate with an application server, which is capable of processing the requests and generating responses using, but not limited to, Java Server Pages (JSP) and servelets. To encapsulate the communication with the database server, the JSPs and servelets use embedded Enterprise Java Beans (EJB) . The EJBs communicate with the database server either through their container which implements a JDBC connection (e.g., using find methods) or by directly encoding JDBC calls using Bean Managed Persistence.

The client may initiate a request to retrieve a tutorial, a component, a problem, a solution, an individual formula, an individual illustration, a hint or a textual, via HTP-Get or HTTP-Post request to the middleware server. The nmiddleware server, often referred to as the application server, transforms the said request into multiple database access queries directed at the database server. These queries could be implemented, e.g., using ODBC/JDBC bridge, or using HTTP-Get/Post requests to the database server. Upon recipt of the data requests, the database server processes the queries and returns the result to the application server either in a record set, as an XML formatted data stream or as a plain-text response. Subsequently, the application server compiles the responses it received from the database servers and computes an html response to the client.

I claim:

1. A database apparatus for storing educational content comprising:
a collection of content components;
a collection of tutorials,
a collection of user profiles;
a mapping between tutorials and content components;
a mapping between user profiles and tutorials;
a collection of sessions; and
a collection of stored procedures.

2. An apparatus as in claim 1 wherein the said components are selected from group consisting of problems, group consisting of problem sets, group consisting of problem descriptions, group consisting of problem statements, group consisting of hints, group consisting of questions, group consisting of Socratic questions, group consisting of guesses, group consisting of queries, group consisting of steps, group consisting of figures and group consisting of images.

3. An apparatus as in claim 1 wherein said components are described in the HM/SL language.

4. An apparatus as in claim 1 wherein said tutorials are selected from a group of solutions, each comprising hints, questions, guesses and steps.

5. An apparatus as in claim 4 wherein the first element in each said solution is a hint.

6. An apparatus as in claim 4 wherein each question and hint is followed by a step.

7. An apparatus as in claim 4 wherein each step, except the last step, is followed by either a question or a hint.

8. An apparatus as in claim 4 wherein each question has at least two guesses, and at least one right guess.

9. An apparatus as in claim 4 wherein each guess has at least one response.

10. An apparatus as in claim 4 wherein each solution record includes at least a problem index, problem number, book title, chapter title, section title, problem set, page number, solution number, XML encoding of the solution, and information about the author.

11. An apparatus as in claim 10 further comprising a database of comments, wherein comment is stamped by a date and refers to a problem index or a solution index.

12. An apparatus as in claim 1 further comprising a database of books, wherein book record includes a text code, text name, edition, publisher, publication date, author, ISBN, and an image of the cover.

13. An apparatus as in claim 1 wherein the said profiles are stored in records which include problem index, user code, grade, grade date and comments.

14. An apparatus as in claim 4 wherein the said tutorials are stored in solution files having a header listing the problem that the tutorial is solving, a code name for the source book and author, and specification of the problem location in that book.

15. An apparatus as in claim 14 wherein the specification of the problem location includes a chapter, section, group, page number and problem number.

16. An apparatus as in claim 4 wherein solutions comprise of hints, guesses, queries, Socratic questions, steps, figures and images.

17. An apparatus as in claim 16 wherein said steps are stored in sequences using an HM/SL format, and have headers identifying a partial solution to a problem

18. An apparatus as in claim 17 wherein said steps include images or graphics.

19. An apparatus as in claim 16 wherein said hits are stored using an HM/SL format, and have headers identifying a clue that the student can display on request.

20. An apparatus as in claim 16 wherein said queries are stored using an HM/SL format, and have headers identifying different ways of continuing the solution.

21. An apparatus as in claim 20 wherein headers specify when queries should be presented to the student.

22. An apparatus as in claim 20 wherein headers specify, for each query, the text of the query followed by at least two Guess-Response pairs.

23. An apparatus as in claim 22 wherein guess-response headers specifying the item that the student will see if the corresponding guess is selected.

24. An apparatus as in claim 16 wherein guess short text representing one possible answer to the query that it follows.

25. An apparatus as in claim 16 wherein figure headers specify an image generated with a drawing or graphing program

26. A method for storing and accessing educational content including the steps of:
accessing the profile of a user;
accessing a tutorial;
accessing content components;
updating content components;
updating the tutorial information;
updating the profile of the users; and
generating a response transmitted over the world-wide-web.

27. A method as in claim 26 wherein the step of accessing a tutorial is preceded by a step of uploading that tutorial by aggregating it into a file and transmitting it to a web-server.

28. A method as in claim 27 wherein the said file has a header listing the problem that the tutorial is solving, and a code name for the source book and author.

29. A method as in claim 26 wherein each tutorial is assembled from a set of solutions, each comprising hints, questions, guesses and steps.

30. A method as in claim 29 wherein the first element in each said solution is a hint, each question and hint is followed by a step, each step, except the last step, is followed by either a question or a hint, question contains at least two guesses, and at least one right guess, and each guess has at least one response.

31. A method as in claim 29 wherein said steps are stored in sequences using an HM/SL format, and have headers identifying a partial solution to a problem

32. A method as in claim 31 wherein said steps include images or graphics.

33. A method as in claim 29 wherein said hints are stored using an HM/SL format, and have headers identifying a clue that the student can display on request.

34. A method as in claim 29 wherein said questions are stored using an HM/SL format, and have headers identifying different ways of continuing the solution.

35. An apparatus as in claim 20 wherein headers specify when queries should be presented to the student.

36. An apparatus as in claim 20 wherein headers specify, for each query, the text of the query followed by at least two Guess-Response pairs.

37. An apparatus as in claim 22 wherein guess-response headers specifying the item that the student will see if the corresponding guess is selected, and short text representing one possible answer to the query that it follows.
